(19) United States
(12) Patent Application Publication
(10) Pub. No.: US 2025/0112366 A1
(43) Pub. Date: Apr. 3, 2025

(54) ANNULAR RADIO-FREQUENCY (RF) ANTENNA SYSTEM FOR GUIDED PROJECTILES

(71) Applicant: The Charles Stark Draper Laboratory, Inc., Cambridge, MA (US)

(72) Inventors: Tom BUCKLAEW, Cambridge, MA (US); Jacob P. TREADWAY, Cambridge, MA (US); George J. GILLESPIE, Cambridge, MA (US)

(73) Assignee: The Charles Stark Draper Laboratory, Inc., Cambridge, MA (US)

(21) Appl. No.: 18/904,433

(22) Filed: Oct. 2, 2024

Related U.S. Application Data
(60) Provisional application No. 63/587,494, filed on Oct. 3, 2023.

(51) Int. Cl. H01Q 7/00; F41G 7/22; G01S 7/03; H01Q 1/28; H01Q 15/24

(52) U.S. Cl. CPC H01Q 7/005; F41G 7/2246; F41G 7/2286; G01S 7/032; H01Q 1/28; H01Q 15/24

(57) ABSTRACT

An annular antenna system comprises a first ring assembly having a first shorting wall and a second ring assembly having a second shorting wall. The second ring assembly is arranged substantially parallel to the first ring assembly. The annular antenna system further comprises four RF ports on a top surface of the first annular conductor at ninety-degree intervals. Each of the RF ports has a housing electrically connected to the first annular conductor and a center conductor electrically connected to the second annular conductor. Each RF port is configured to receive and apply an RF signal to the first ring assembly. The first ring assembly comprises first and second annular conductors, and the first shorting wall electrically couples the first and second annular conductors. The second ring assembly comprises a third and fourth annular conductors, and the second shorting wall electrically couples the third and fourth annular conductors.

### CROSS REFERENCE TO RELATED APPLICATIONS

This application claims priority to U.S. Provisional Patent Application Ser. No. 63/587,494 filed on Oct. 3, 2023, the entire content of which is hereby incorporated by reference herein.

### BACKGROUND

In some applications, a guided projectile may require a radio frequency (RF) antenna for sensing and communication. Such projectile antennas often are situated at the tapered, leading end of the projectile. Ring-type antennas may be suitable for such purposes as they can facilitate an aerodynamic profile and be located at the middle or trailing end of the projectile. The radiation patterns of existing ring antennas, however, may be adversely and/or unpredictably affected by wires, components, and other materials that are present within the interior of the ring. Further, the current distribution across existing ring antenna designs tends to be uniform, which produces a fixed antenna radiation pattern.

### SUMMARY

Aspects of the present disclosure provide, generally, an annular antenna system that produces a directional radiation pattern, the direction of which can be controlled. The radio frequency (RF) energy sourced by the described systems may be of linear polarization, left-hand circular polarization (LHCP), or right-hand circular polarization (RHCP), depending on how the input signal is fed to the annular antenna system. Applications of varying RF signals allow the antenna system to be utilized in varying applications, including but not limited to proximity detection and angular positions between two objects.

According to one aspect, an annular antenna system may include a first ring assembly that comprises a first annular conductor, a second annular conductor, a first shorting wall that electrically couples the first annular conductor to the second annular conductor, and at least two RF ports, each of which is configured to receive an RF signal and apply the RF signal across the first annular conductor and the second annular conductor.

The annular antenna system may include, alone or in combination, one or more of the following features. The first annular conductor may comprise a first top surface, a first bottom surface, a first inner periphery and a first outer periphery. The second annular conductor may include a second top surface, a second bottom surface, a second inner periphery and a second outer periphery. The shorting wall may electrically couple the first inner periphery to the second inner periphery. The first top surface may be substantially parallel to the second top surface. The first annular conductor may be separated from the second annular conductor by a dielectric material. The first ring assembly may be integrated with a projectile such that the first outer periphery and the second outer periphery are substantially flush with an outer surface of the projectile. A distance from the first inner periphery to the first outer periphery may be λ/4, where λ is a wavelength at an operating frequency of the annular antenna system. The annular antenna system may further comprise a second ring assembly that includes a third annular conductor, a fourth annular conductor, and a second shorting wall that electrically couples the third annular conductor to the fourth annular conductor. The first ring assembly may be characterized by a first set of physical dimensions, the second ring assembly is characterized by a second set of physical dimensions, and the first set of physical dimensions is substantially the same as the second set of physical dimensions. A row of at least two electrically conductive posts may be disposed such that each of the electrically conductive posts being electrically coupled to the first annular conductor and to the second annular conductor. Four RF ports may be distributed on a top surface of the first annular conductor at ninety-degree intervals. Each of the RF ports may have a housing electrically connected to the first annular conductor and a center conductor electrically connected to the second annular conductor. An isolating wall may be disposed between at least two adjacent RF ports, each isolating wall being electrically coupled to the first annular conductor and to the second annular conductor. The isolating wall may comprise a row of at least two conductive vias.

In another aspect, a method of determining a position of a first object in relation to a second object may include disposing an annular antenna system on the first object. The annular antenna system may comprise a first ring assembly that includes a first annular conductor, a second annular conductor, a first shorting wall that electrically couples the first annular conductor to the second annular conductor, and a RF port disposed on the first annular conductor. The RF port may be configured to receive an RF signal and apply the RF signal across the first annular conductor and the second annular conductor. The method may further comprise applying an RF signal pulse to the RF port, and determining position of the first object in relation to the second object based on a detected return signal.

The method may further include, alone or in combination, one or more of the following features. Determining the position of the first object in relation to the second object may include determining the first object is within a predetermined proximity of the second object when the return signal detected at the at least one RF port is greater than a threshold value corresponding to the predetermined proximity. The at least one RF port may include four RF ports disposed at ninety-degree intervals on the first annular conductor. The at least one RF signal pulse to the at least one RF port may include applying a first RF signal pulse to each of the four RF ports. The four RF ports may receive signals with equal magnitudes and phases that advance by ninety degrees from RF port to RF port. A first return signal may be received corresponding to the first RF signal pulse. A second RF signal pulse may be applied to each of the four RF ports. The four RF ports may receive equal magnitude signals and equal phase signals. A second return signal may be received corresponding to the second RF signal pulse. Determining the position of the first object in relation to the second object may include performing monopulse processing to determine that the first object is at a predetermined angle away from a longitudinal axis of a second object.

In another aspect, an annular antenna system may include a first ring assembly having a first shorting wall, and a second ring assembly having a second shorting wall. The second ring assembly may be substantially parallel to the first ring assembly. The annular antenna system may further comprise four RF ports distributed on a top surface of the first annular conductor at ninety-degree intervals. Each of the RF ports may have a housing electrically connected to the first annular conductor and a center conductor electrically connected to the second annular conductor. Each RF port may be configured to receive an RF signal and apply the RF signal to the first ring assembly.

The annular antenna system may further include, alone or in combination, one or more of the following features. The first ring assembly may comprise a first annular conductor and a second annular conductor. The first shorting wall may electrically couple the first annular conductor to the second annular conductor. The second ring assembly may comprise a third annular conductor and a fourth annular conductor. The second shorting wall may electrically couple the third annular conductor to the fourth annular conductor. The first annular conductor may comprise a first top surface, a first bottom surface, a first inner periphery and a first outer periphery. The second annular conductor may comprise a second top surface, a second bottom surface, a second inner periphery and a second outer periphery. The first annular conductor may be separated from the second annular conductor by a dielectric material.

### BRIEF DESCRIPTION OF THE DRAWINGS

The patent or application file contains at least one drawing executed in color. Copies of this patent or patent application publication with color drawings will be provided by the Office upon request and payment of the necessary fee.

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIG. 1A is an isometric view of an annular antenna system, according to one or more aspects of the present disclosure;

FIG. 1B is a top view of the annular antenna system of FIG. 1A, according to one or more aspects of the present disclosure;

FIG. 1C is a bottom view of the annular antenna system of FIG. 1A, according to one or more aspects of the present disclosure;

FIG. 1D is a partial side view of the annular antenna system of FIG. 1A, according to one or more aspects of the present disclosure;

FIG. 1E is a partial sectional view of the annular antenna system of FIG. 1D taken across line A-A, according to one or more aspects of the present disclosure;

FIG. 1F is a partial side view of the annular antenna system of FIG. 1A, according to one or more aspects of the present disclosure;

FIG. 2A are gain plots of a three-dimensional (3D) radiation pattern from an example first ring, according to one or more aspects of the present disclosure;

FIG. 2B are gain plots of a 3D radiation pattern produced by an example two-ring assembly, according to one or more aspects of the present disclosure;

FIG. 3A are gain plots of a 3D radiation pattern for an example annular antenna system with no shorting vias in the first ring assembly and the second ring assembly;

FIG. 3B are gain plots of a 3D radiation pattern for an annular antenna system with shorting vias in both the first ring assembly and the second ring assembly;

FIG. 4A is a is gain plot of a 3D radiation pattern from a single-port excitation of an exemplary antenna system, viewed along a y-axis, according to one or more aspects of the present disclosure;

FIG. 4B is a gain plot of a 3D radiation pattern from a single-port excitation of an exemplary antenna system, viewed along a z-axis, according to one or more aspects of the present disclosure;

FIG. 4C is a gain plot of a 3D radiation pattern from a single-port excitation of an exemplary antenna system, viewed along an x-axis, according to one or more aspects of the present disclosure;

FIG. 5A is a gain plot of a 3D radiation pattern from a four-port excitation of an exemplary antenna system using the same signal, viewed along a y-axis, according to one or more aspects of the present disclosure;

FIG. 5B is a gain plot of a 3D radiation pattern from a four-port excitation of an exemplary antenna system using the same signal, viewed along a z-axis, according to one or more aspects of the present disclosure;

FIG. 5C is a gain plot of a 3D radiation pattern from a four-port excitation of an exemplary antenna system using the same signal, viewed along an x-axis, according to one or more aspects of the present disclosure;

FIG. 6A is a gain plot of a 3D radiation pattern from a four-port excitation of an exemplary antenna system using the signals of the same magnitude but with phases that increment by ninety degrees in a clockwise direction, viewed along a y-axis, according to one or more aspects of the present disclosure;

FIG. 6B is a gain plot of a 3D radiation pattern from a four-port excitation of an exemplary antenna system using the signals of the same magnitude but with phases that increment by ninety degrees in a clockwise direction, viewed along a z-axis, according to one or more aspects of the present disclosure;

FIG. 6C is a gain plot of a 3D radiation pattern from a four-port excitation of an exemplary antenna system using the signals of the same magnitude but with phases that increment by ninety degrees in a clockwise direction, viewed along an x-axis, according to one or more aspects of the present disclosure;

FIG. 7A is a gain plot of a 3D radiation pattern from a four-port excitation of an exemplary antenna system using the signals of the same magnitude but with phases that increment by ninety degrees in a clockwise direction, viewed along a y-axis, according to one or more aspects of the present disclosure;

FIG. 7B is a gain plot of a 3D radiation pattern from a four-port excitation of an exemplary antenna system using the signals of the same magnitude but with phases that increment by ninety degrees in a clockwise direction, viewed along a z-axis, according to one or more aspects of the present disclosure;

FIG. 7C is a gain plot of a 3D radiation pattern from a four-port excitation of an exemplary antenna system using the signals of the same magnitude but with phases that increment by ninety degrees in a clockwise direction, viewed along an x-axis, according to one or more aspects of the present disclosure; and

FIG. 8 is as flow diagram of a method of determining a position of an object, according to one or more aspects of the present disclosure.

### DETAILED DESCRIPTION

Aspects of the present disclosure provide an annular antenna system that produces a controllable directional radiation pattern. The radio frequency (RF) energy sourced by the antenna systems described herein may be of linear polarization, left-hand circular polarization (LHCP), or right-hand circular polarization (RHCP), depending on how the input signal is fed to the annular antenna system. For example, the annular antenna system, as disclosed herein, may be configured according to one or more aspects to determine whether an object is within a predetermined proximity to another object and/or whether an object is positioned at a predetermined angle from a second object. One of skill in the art, however, will recognize that the annular antenna systems disclosed herein are not limited to these applications and additional configurations and applications may be implemented without deviating from the scope of the disclosure.

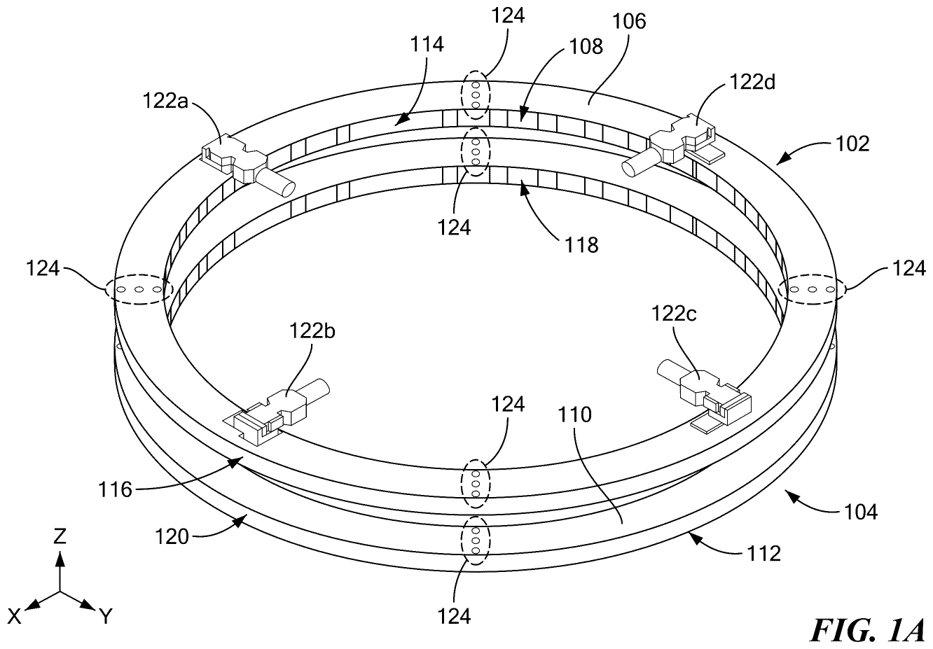

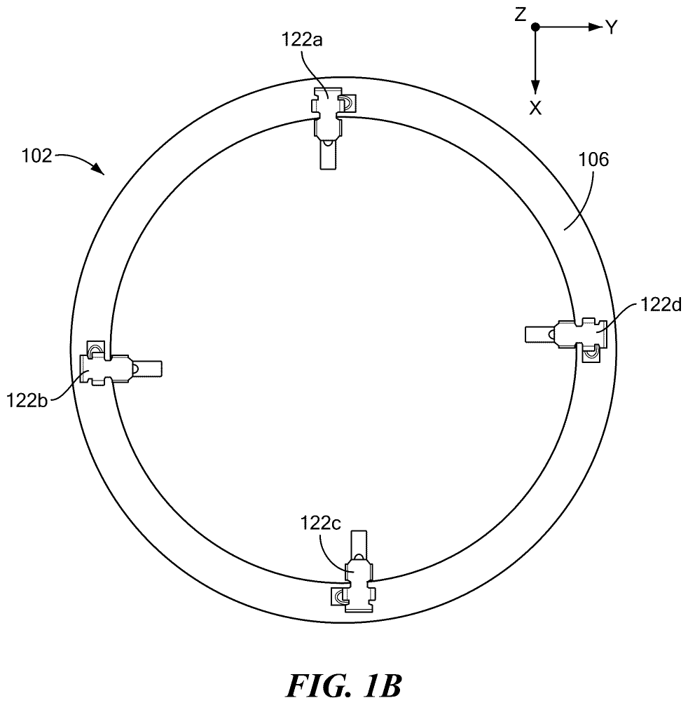

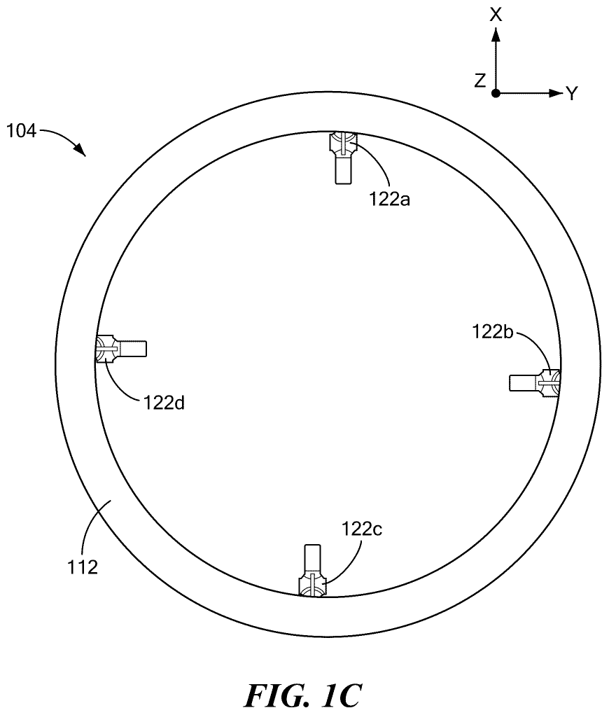

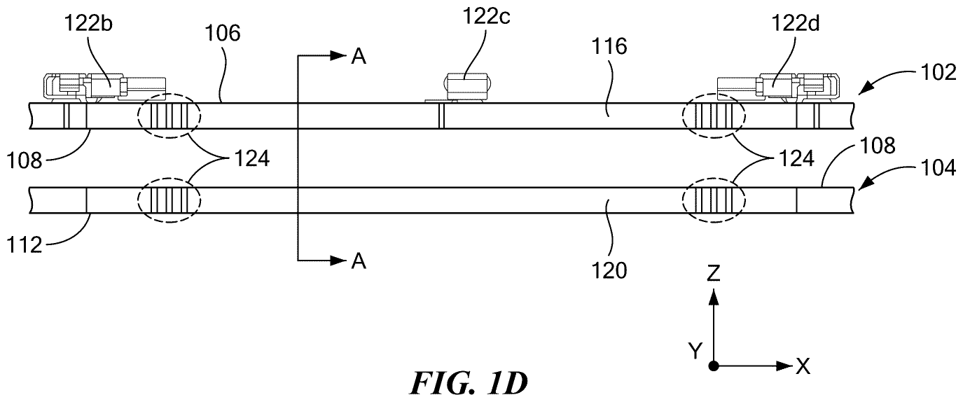

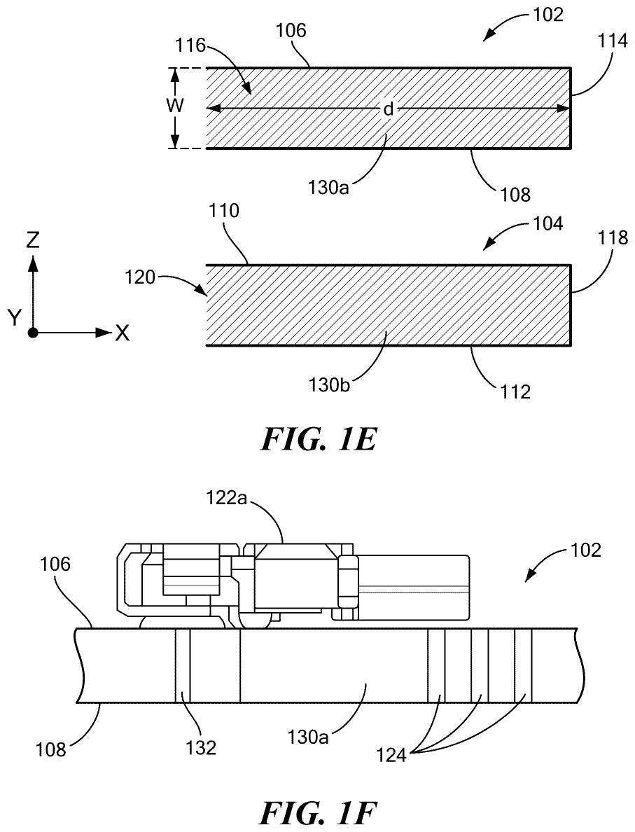

Referring to FIGS. 1A-1F, an exemplary annular antenna system 100 is shown with respect to a three-dimensional (3D), x, y, z coordinate system, according to one or more aspects of the disclosure. FIG. 1A is an isometric view of the annular antenna system 100, while FIG. 1B and FIG. 1C are top and bottom views, respectively. According to one aspect, the annular antenna system may include a first ring assembly 102 and a second ring assembly 104. The first ring assembly 102 may include a first annular conductor 106, a second annular conductor 108, a first inner shorting wall 114, and a first radiating face 116. The first inner shorting wall 114 may electrically couple the first annular conductor 106 to the second annular conductor 108. According to one aspect, the first annular conductor 106 and the second annular conductor 108 may be arranged substantially parallel to one another, and separated by a dielectric material 130a, as explained in more detail below with respect to FIGS. 1E and 1F. The first annular conductor 106, the second annular conductor 108 and the first inner shorting wall 114 may form a planar inverted-F antenna (PIFA), which has been rotated about the z-axis.

According to one aspect, the second ring assembly 104 may include a third annular conductor 110, a fourth annular conductor 112, a second inner shorting wall 118, and a second radiating face 120. The inner shorting wall 118 may electrically couple the top annular conductor 110 to the bottom annular conductor 112. The third annular conductor 110 and the fourth annular conductor 112 may be arranged substantially parallel to one another and separated by a dielectric material 130b similar to the first and second annular conductors of the first ring assembly 102. The dielectric material 130a, 130b in the example embodiment may be or include Rogers 3006 Substrate, although other dielectric materials may alternatively be used.

According to one aspect, the first ring assembly 102 may further include four RF ports, for example coaxial connectors 122a, 122b, 122c, 122d, which may be distributed on the first annular conductor 106 at about ninety-degree intervals from each other about the z-axis, as shown in FIG. 1B. The housing of each coaxial connector (corresponding to the shielding of the associated coaxial transmission line) may be physically attached and electrically coupled to the first annular conductor 106. The signal conductor of each coaxial connector (corresponding to the center conductor of the associated coaxial transmission line) may be conveyed through a via 132 (FIG. 1F), or an electrically conductive post, formed in the dielectric material 130a to the second annular conductor 108.

According to one aspect, an RF signal may be propagated through a transmission line (e.g., a coaxial transmission line) to the signal conductor of one of the coaxial connectors 122a, 122b, 122c, 122d, and subsequently conveyed to the second annular conductor 108. The RF signal applied to the second annular conductor 108 with respect to the first annular conductor 106 of the associated coaxial connector may cause an RF propagating waveform to be transmitted from the first radiating face 116. Accordingly, the first ring assembly 102 may therefore be considered an active antenna element.

In a transmit mode, according to one aspect, the first ring assembly 102 may be excited by RF signals applied through the four coaxial connectors 122a, 122b, 122c, 122d. In a receive mode, the first ring assembly 102 may provide received signals to the four coaxial connectors 122a, 122b, 122c, 122d.

FIG. 1D shows a partial side view of the example annular antenna system 100, in which the first ring assembly 102 may include the first annular conductor 106, the second annular conductor 108, and the first radiating face 116. The second ring assembly 104 may include the third annular conductor 110, the fourth annular conductor 112, and the second radiating face 120. According to one aspect, the second ring assembly 104 may have no ports for receiving an excitation signal or producing a received signal. The second ring assembly 104 thus may operate as an inactive (i.e., non-driven) antenna component in conjunction with the first ring assembly 102. For example, the RF energy radiated from the active first ring assembly 102 in the direction of the passive second ring assembly 104 may be re-radiated by the passive second ring assembly 104. The re-radiated RF energy may be out of phase with respect to the RF energy radiated by the active first ring assembly 102, so the passive ring radiation may cancel the active ring radiation in a backward direction.

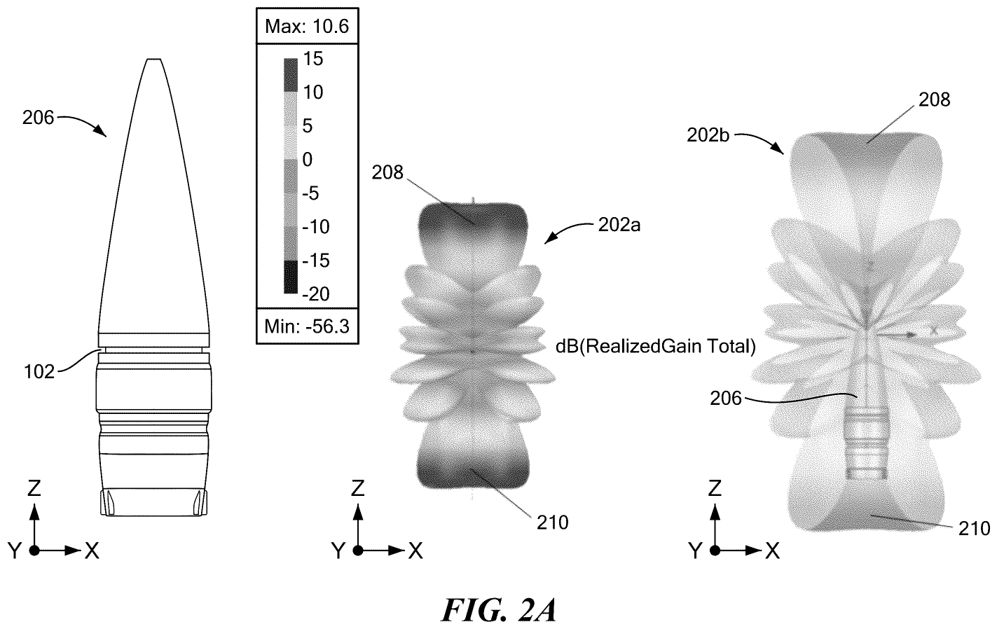

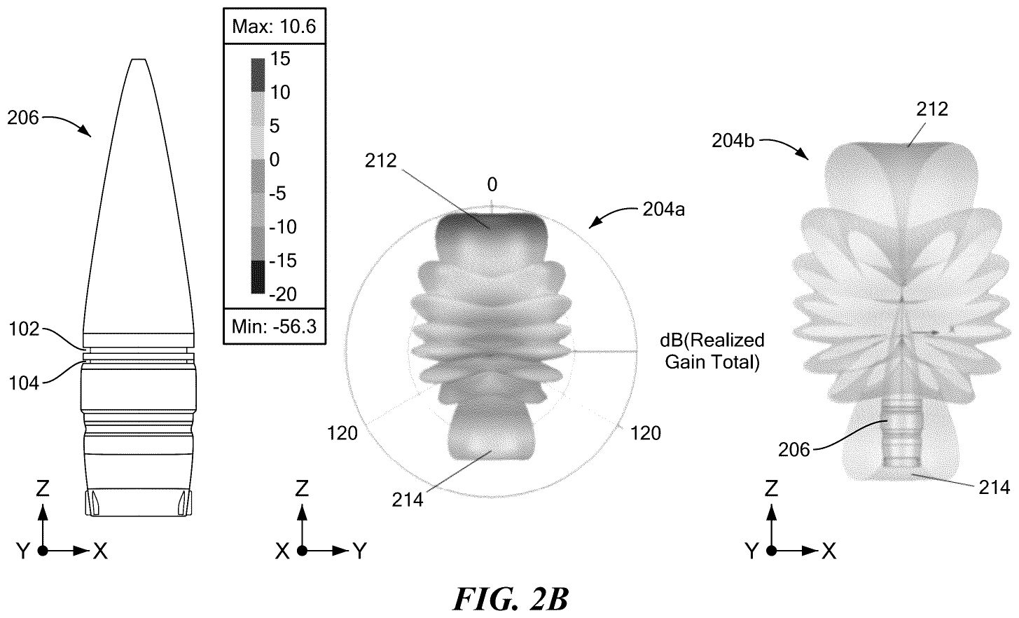

FIG. 2A shows gain plots 202a, 202b of a 3D radiation pattern from the example first ring assembly 102, as described herein, integrated with an example projectile 206. As this radiation pattern shows, with the single first ring assembly 102, a front-directed portion 208 of the radiation pattern may be substantially the same as a rear-directed portion 210. FIG. 2B shows gain plots 204a, 204b of a 3D radiation pattern produced by the example active first ring assembly 102 in conjunction with a passive second ring assembly 104, as described herein. Comparing gain plots 202a and 202b of FIG. 2A to the gain plots 204a, 204b of FIG. 2B demonstrates that the inclusion of the passive ring assembly 104 may cause a rear-directed portion 214 to be reduced as compared to a front-directed portion 212.

Returning now to FIGS. 1D-1E a partial side-view of the example annular antenna system 100 shows three of the coaxial connectors 122b, 122c, 122d (in this view, coaxial connector 122a is hidden behind coaxial connector 122c). FIG. 1E depicts a sectional view of the example annular antenna system 100, taken across line A-A in FIG. 1D. According to one aspect, a distance d from the shorting wall 114 to the first radiating face 116 may be about one fourth of the wavelength (λ/4) at the ring antenna's operating frequency, and a width w may be at least about 10*d. One skilled in the art will recognize that different values of d and w may be implemented without deviating from the scope of the present disclosure.

According to one aspect, the shorting wall 114 may facilitate placement of electrical components and other objects within the first ring assembly 102 and the second ring assembly 104 without substantially affecting the overall antenna radiation pattern. For example, a ring assembly without a shorting wall may exhibit a second radiating face at the location of the missing shorting wall (i.e., a radiating face directed toward the interior of the ring). Consequently, electrical components and other objects placed within a ring assembly, like the first and second ring assemblies 102, 104, without the shorting wall may reflect and/or absorb the interior-directed radiation, thereby interfering with the overall radiation pattern.

According to one aspect, the first ring assembly 102 and the second ring assembly 104 described herein may also include one or more shorting vias 124, that electrically couple the first annular conductor 106 to the second annular conductor 108 in the first ring assembly 102, and electrically couple the third annular conductor 106 to the second annular conductor 108 in the first ring assembly, as shown in FIGS. 1A and 1F. According to one aspect, the annular antenna system 100 may include sets of shorting vias 124 placed between each pair of coaxial connectors, thereby forming isolating walls between adjacent pairs of coaxial connectors. These isolating walls, formed by vias 124, may prevent fields and currents generated by one coaxial connector from interfering with fields and currents created by the other coaxial connector feeds, and vice versa. According to one aspect, the sets of shorting vias 124 may be situated at about ninety-degree intervals from each other about the z-axis, offset by about forty-five degrees with respect to the coaxial connectors. Scattering parameters (S-parameters) of a particular RF port (e.g. coaxial connector ports) may be substantially unaffected by the other RF ports due to the shorting vias 124.

According to one aspect, each isolating wall may be formed by three conductive vias 124 connecting the first annular conductor 106 to the second annular conductor 108, creating a “picket fence” arrangement of vias 124. One skilled in the art, however, will recognize that other numbers of conductive vias 124 and other arrangements of the vias 124 may be used to form an isolating wall between signal feed regions without deviating from the scope of the present disclosure. According to one aspect, the passive second ring assembly 104 may also include shorting vias 124 at locations corresponding to the shorting vias 124 in the first ring assembly 102. The matching shorting vias 124 in the second ring assembly may facilitate the partial or total cancelling of the rear-directed portion of a radiation pattern as described herein. According to one aspect, the total or partial cancelling may be more effective when the physical structure of the passive second ring assembly 104 matches the physical structure of the active first ring assembly 102. This may be due to the re-radiation by the passive second ring assembly 104 being more nearly an inverted version of the radiation pattern of the active first ring assembly 102.

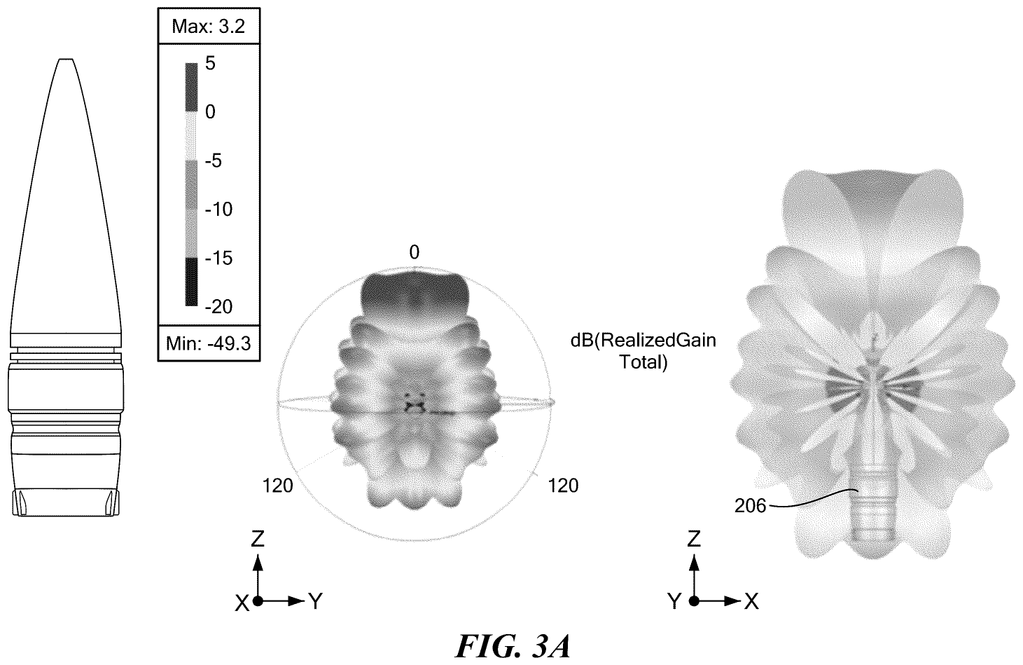

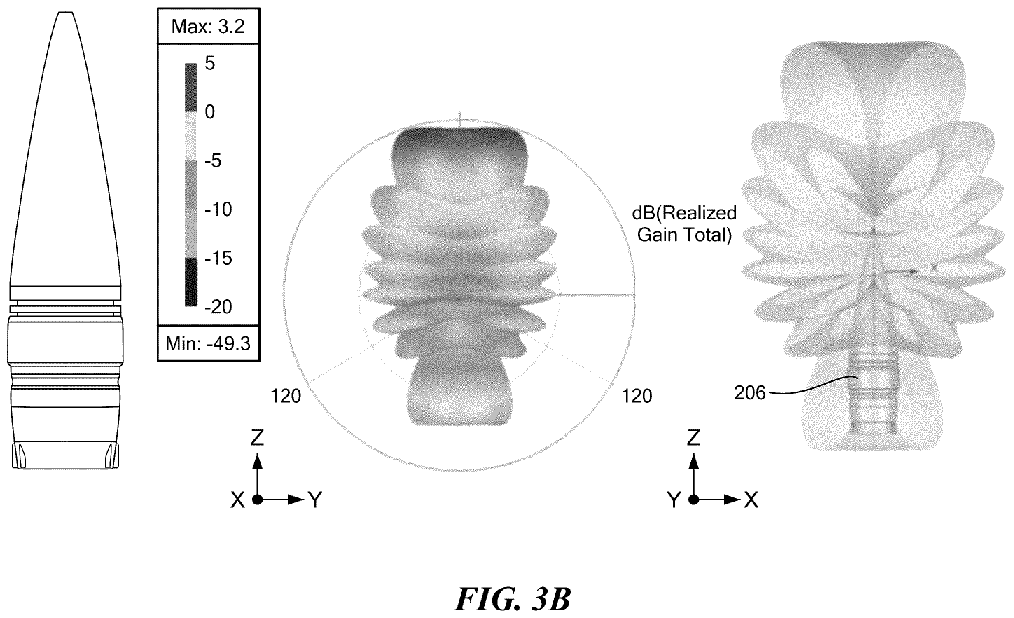

FIG. 3A shows the three-dimensional (3D) radiation pattern 302 for an example annular antenna system 100 with no shorting vias in the first ring assembly 102 or the second ring assembly 104. FIG. 3B shows the 3D radiation pattern 304 for an annular antenna system 100 with shorting vias in both the first ring assembly 102 and the second ring assembly 104. Comparing the radiation pattern 302 of FIG. 3A to the radiation pattern 304 of FIG. 3B indicates that the shorting vias may improve return loss characteristics and the front-directed radiation pattern of the annular antenna system 100.

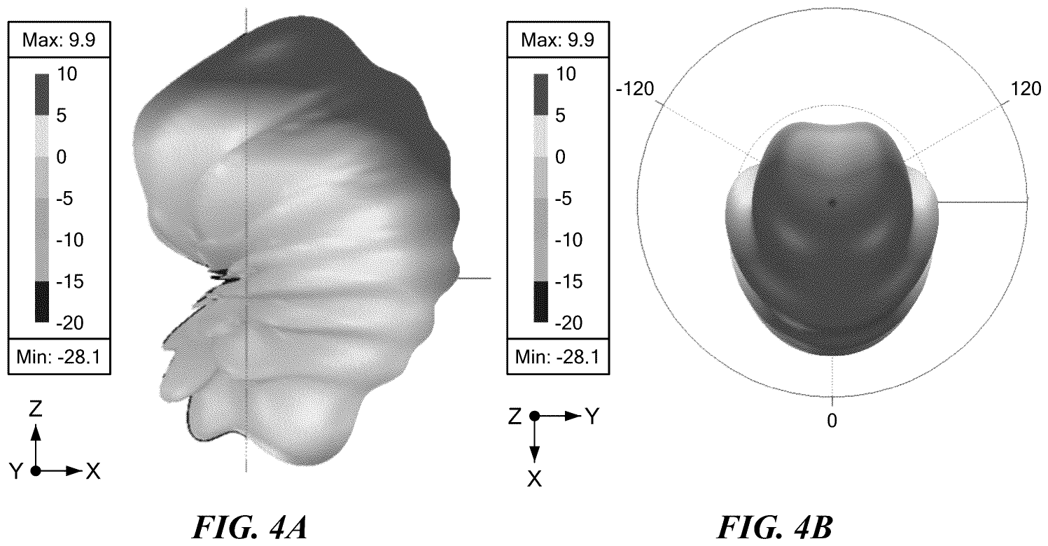

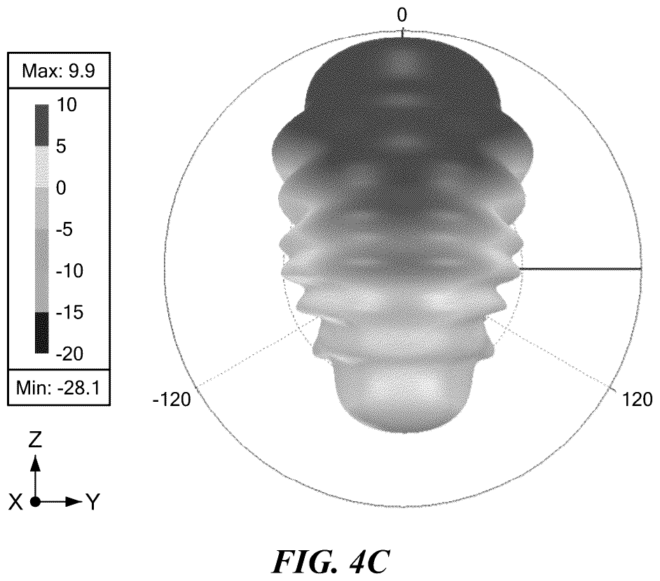

According to one or more aspects of the present disclosure, annular antenna systems, such as annular antenna system 100, may be tuned or otherwise adapted using varying input signals to the RF ports, like coaxial connectors 122a, 122b, 122c, 122d. The input RF signals may be varied according to the number of excited ports, or the RF signals input to the ports, including phase shifts and directionality of the phase shifts. FIGS. 4A-7C are plots of the radiation patterns of the annular antenna system 100 according to varying RF input signals.

According to one aspect, referring to FIGS. 4A, 4B, and 4C, the annular antenna system 100 may have a single RF port excited with an RF signal. FIG. 4A shows an exemplary radiation pattern 402, viewed along a y-axis, while FIGS. 4B and 4C show the radiation pattern 402 along the z-axis and x-axis, respectively. According to one aspect, given the directionality of the radiation pattern in the x-direction, the configuration of the annular antenna system 100 may be effectively implemented in a proximity sensor application. The received RF signal may be compared to a predetermined threshold to determine whether the received RF signal exceeds the threshold, thereby indicating presence of an object within a predetermined proximity to a second object.

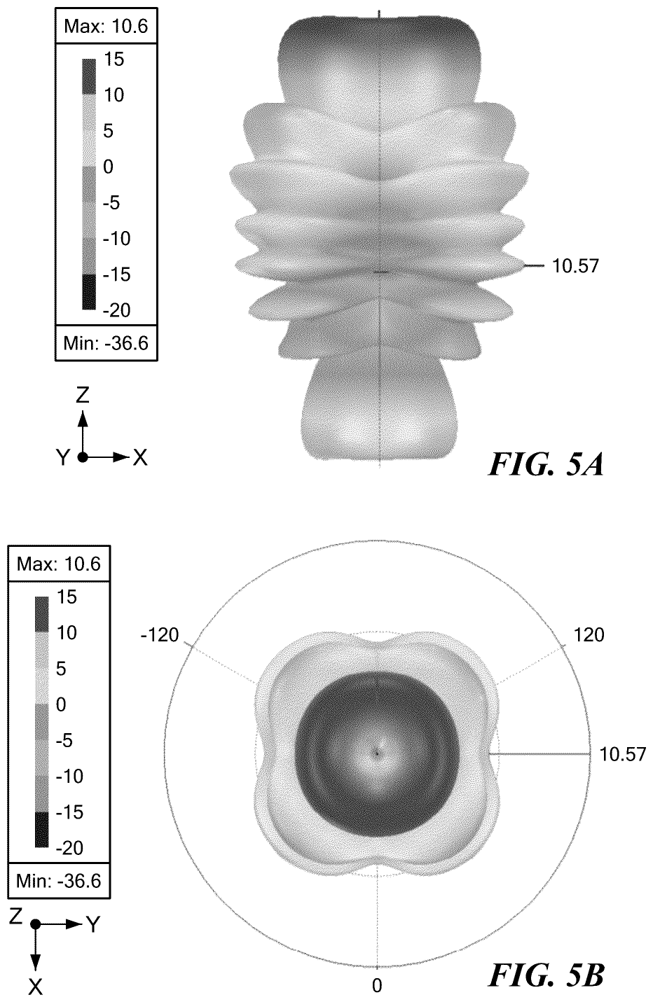

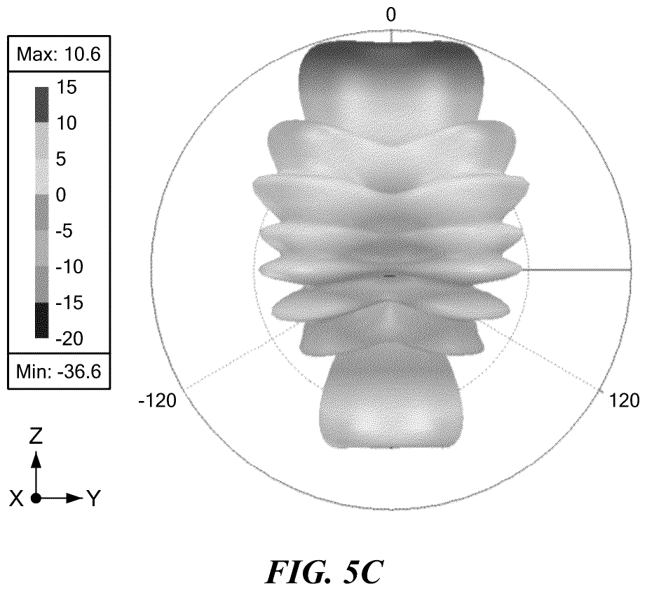

According to another aspect, the annular antenna system 100 may be configured or implemented to excite all four RF ports (e.g., coaxial connectors 122a, 122b, 122c, 122d) with substantially the same RF input signal. FIGS. 5A, 5B, and 5C illustrate the antenna radiation patterns 502 of the example annular antenna system when along the y-axis (FIG. 5A), the z-axis (FIG. 5B), and the x-axis (FIG. 5C). As best shown in FIG. 5B, a null 504 exists along the z-axis, which, according to one aspect, may facilitate sum-difference monopulse or monopulse-like processing.

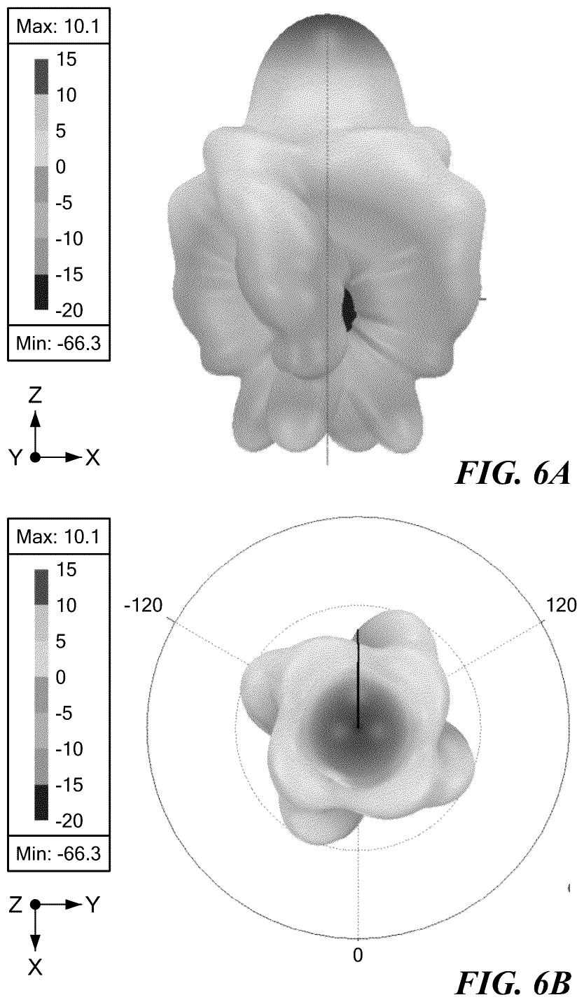

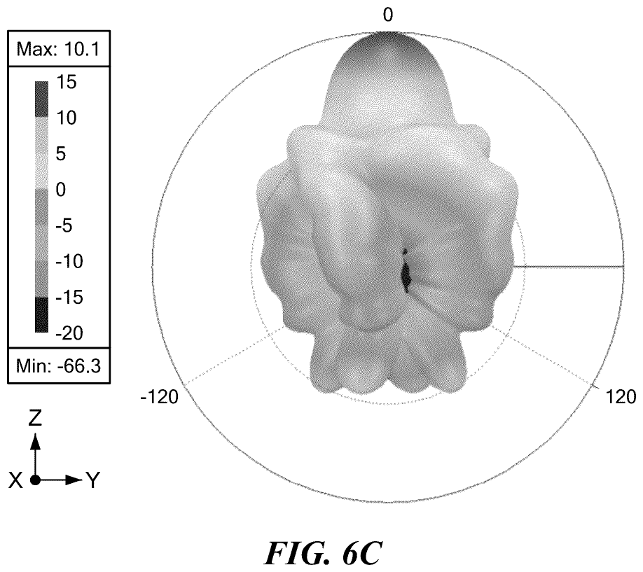

In another aspect, the annular antenna system 100 may be implemented with the excitation of all four RF ports (e.g., coaxial connectors 122a, 122b, 122c, 122d) RF signals having the same magnitude, but with phases that increment counter-clockwise by ninety degrees for each adjacent set of ports. FIGS. 6A, 6B, and 6C illustrate the antenna radiation patterns 602 of the example annular antenna system viewed along the y-axis (FIG. 6A), the z-axis (FIG. 6B), and the x-axis (FIG. 6C). According to one aspect, the phases of the input signals may increase from RF port to RF port in a counter-clockwise direction, looking in towards the front of the example projectile along the z-axis, to produce an RF waveform that is right-hand circularly polarized (RHCP) and directed towards the front of the example projectile.

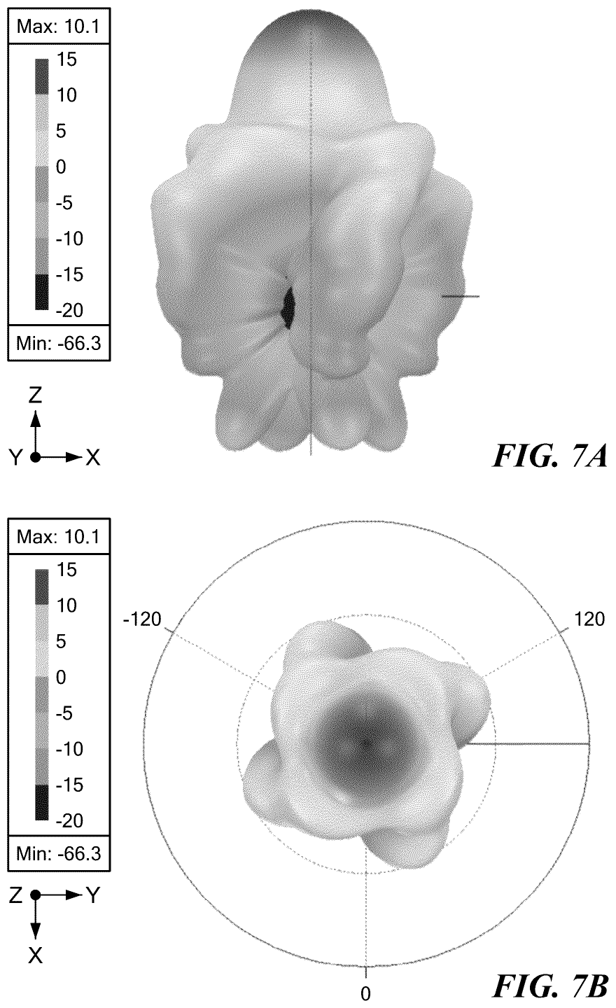

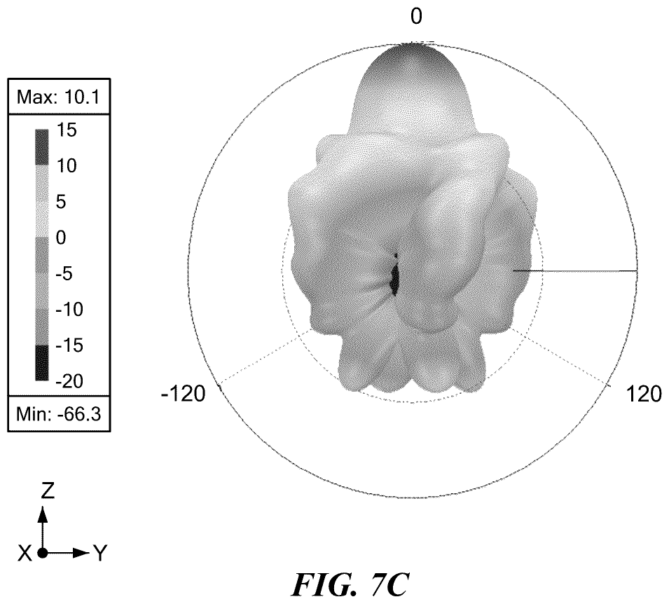

Alternatively, according to one aspect, the annular antenna system 100 may be implemented with the excitation of all four RF ports (e.g., coaxial connectors 122a, 122b, 122c, 122d) with RF signals having the same magnitude, but with phases that increment clockwise by ninety degrees for each adjacent set of ports. FIGS. 7A, 7B, and 7C illustrate the antenna radiation patterns 702 of the example annular antenna system when along the y-axis (FIG. 7A), the z-axis (FIG. 7B), and the x-axis (FIG. 7C). According to one aspect, the phases of the RF input signals may increase from RF port to RF port in a clockwise direction, looking in towards the front of the example projectile along the z-axis, to produce an RF waveform that is left-hand circularly polarized (LHCP) and directed towards the front of the example projectile.

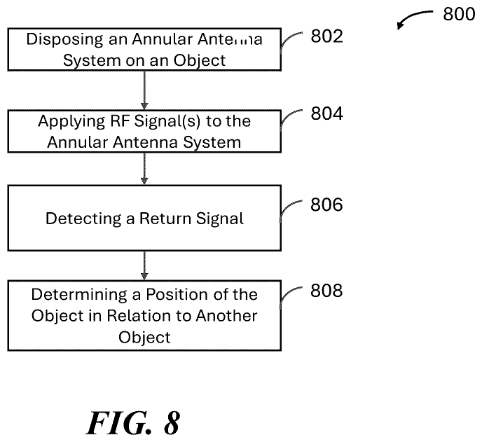

FIG. 8 is a flow diagram of a method 800 of determining a position of an object according to one or more aspects of the disclosure. As described herein, an annular antenna system may be configured and implemented to transmit and receive RF signals in varied ways to determine one or more positions of an object, for example a first object in relation to a second object. According to one aspect, the annular antenna system may be utilized to determine whether the first object is within a predetermined proximity to the second object and/or whether the first object is at a predetermined angle away from a second object, for example, with respect to a longitudinal axis of the second object.

As shown in block 802, an annular antenna system may be disposed on a first object, for example a projectile, as described herein. The annular antenna system, similar to the annular antenna system 100 described above, may include a first ring assembly including a first annular conductor, a second annular conductor, a first shorting wall that electrically couples the first annular conductor to the second annular conductor, and one or more RF ports disposed on the first annular conductor. According to one aspect, in a configuration for detecting whether the first object is a predetermined angle away from the second object, the annular antenna system may include four RF ports disposed at about ninety-degree intervals from each other.

As shown in block 804, one or more RF signals may be applied to the RF ports. In the case of proximity detection, one RF signal may be applied to a single RF port. In the case of determining the angular position, a first RF signal pulse may be sent to each RF port. The four RF ports may receive signals having equal magnitudes and phases that advance by ninety degrees from RF port to RF port. A second RF signal pulse may be applied to each RF port. The four RF ports may receive equal magnitude signals and equal phase signals.

As shown in block 806, return RF signals from the second object may be detected by the annular antenna system. When determining the angular position of the first object in relation to the second object, each of the four RF ports may receive a first return signal corresponding to the first RF signal pulse. The four RF ports may also receive a second return signal corresponding to the second RF signal pulse.

As shown in block 808, a position, for example either a predetermined proximity or a predetermined angle, may be determined based on the RF return signals. According to one aspect, the system may determine whether the first object is within a predetermined proximity to the second object by comparing the return RF signal to a predetermined threshold. If the RF signal is greater than the threshold, the first object may be within the predetermined proximity. If the return signal is less than the threshold, the first object is outside of the predetermined proximity. According to another aspect, the system may determine whether the first object is within a predetermined angle of the second object by performing monopulse or monopulse-like processing of the first return signal and the second return signal.

Based on the teachings, one skilled in the art should appreciate that the scope of the present disclosure is intended to cover any aspect of the present disclosure, whether implemented independently of or combined with any other aspect of the present disclosure. For example, an apparatus may be implemented or a method may be practiced using any number of the aspects set forth. In addition, the scope of the present disclosure is intended to cover such an apparatus or method practiced using other structure, functionality, or structure and functionality in addition to, or other than the various aspects of the present disclosure set forth. It should be understood that any aspect of the present disclosure may be embodied by one or more elements of a claim.

Although reference is made herein to particular materials, it is appreciated that other materials having similar functional and/or structural properties may be substituted where appropriate, and that a person having ordinary skill in the art would understand how to select such materials and incorporate them into embodiments of the concepts, techniques, and structures set forth herein without deviating from the scope of those teachings.

Various embodiments of the concepts, systems, devices, structures and techniques sought to be protected are described herein with reference to the related drawings. Alternative embodiments can be devised without departing from the scope of the concepts, systems, devices, structures and techniques described herein. It is noted that various connections and positional relationships (e.g., over, below, adjacent, etc.) are set forth between elements in the following description and in the drawings. These connections and/or positional relationships, unless specified otherwise, can be direct or indirect, and the described concepts, systems, devices, structures and techniques are not intended to be limiting in this respect. Accordingly, a coupling of entities can refer to either a direct or an indirect coupling, and a positional relationship between entities can be a direct or indirect positional relationship.

As used herein, the terms “comprises,” “comprising, “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance, or illustration. Any embodiment or design described herein as “exemplary” is not necessarily to be construed as preferred or advantageous over other embodiments or designs. The terms “one or more” and “one or more” are understood to include any integer number greater than or equal to one, i.e., one, two, three, four, etc. The terms “a plurality” are understood to include any integer number greater than or equal to two, i.e., two, three, four, five, etc. The term “connection” can include an indirect “connection” and a direct “connection.”

References in the specification to “one embodiment, “an embodiment,” “an example embodiment,” etc., indicate that the embodiment described can include a particular feature, structure, or characteristic, but every embodiment can include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

For purposes of the description hereinafter, the terms “upper,” “lower,” “right,” “left,” “vertical,” “horizontal, “top,” “bottom,” and derivatives thereof shall relate to the described structures and methods, as oriented in the drawing figures. The terms “overlying,” “atop,” “on top, “positioned on” or “positioned atop” mean that a first element, such as a first structure, is present on a second element, such as a second structure, where intervening elements such as an interface structure can be present between the first element and the second element. The term “direct contact” means that a first element, such as a first structure, and a second element, such as a second structure, are connected without any intermediary elements.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

The terms “approximately” and “about” may be used to mean within ±20% of a target value in some embodiments, within ±10% of a target value in some embodiments, within ±5% of a target value in some embodiments, and yet within ±2% of a target value in some embodiments. The terms “approximately” and “about” may include the target value. The term “substantially equal” may be used to refer to values that are within ±20% of one another in some embodiments, within ±10% of one another in some embodiments, within ±5% of one another in some embodiments, and yet within ±2% of one another in some embodiments.

The term “substantially” may be used to refer to values that are within ±20% of a comparative measure in some embodiments, within ±10% in some embodiments, within ±5% in some embodiments, and yet within ±2% in some embodiments. For example, a first direction that is “substantially” perpendicular to a second direction may refer to a first direction that is within ±20% of making a ninety-degree angle with the second direction in some embodiments, within ±10% of making a ninety-degree angle with the second direction in some embodiments, within ±5% of making a ninety-degree angle with the second direction in some embodiments, and yet within ±2% of making a ninety-degree angle with the second direction in some embodiments.

As used herein, the term “determining” encompasses a wide variety of actions. For example, “determining” may include calculating, computing, processing, deriving, investigating, looking up (e.g., looking up in a table, a database or another data structure), ascertaining and the like. Additionally, “determining” may include receiving (e.g., receiving information), accessing (e.g., accessing data in a memory) and the like. Furthermore, “determining” may include resolving, selecting, choosing, establishing, and the like.

As used herein, a phrase referring to “at least one of” a list of items refers to any combination of those items, including single members. As an example, “at least one of: a, b, or c” is intended to cover: a, b, c, a-b, a-c, b-c, and a-b-c. Further, the use of the object ‘a’, as used herein is intended to mean “one or more” and, unless specifically stated, is not limited to only one.

It is to be understood that the disclosed subject matter is not limited in its application to the details of construction and to the arrangements of the components set forth in the following description or illustrated in the drawings. The disclosed subject matter is capable of other embodiments and of being practiced and carried out in various ways. Also, it is to be understood that the phraseology and terminology employed herein are for the purpose of description and should not be regarded as limiting. As such, those skilled in the art will appreciate that the conception, upon which this disclosure is based, may readily be utilized as a basis for the designing of other structures, methods, and systems for carrying out the several purposes of the disclosed subject matter. Therefore, the claims should be regarded as including such equivalent constructions insofar as they do not depart from the spirit and scope of the disclosed subject matter.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

While example embodiments have been particularly shown and described, it will be understood by those skilled in the art that various changes in form and details including radiation levels, dimensions and materials, may be made therein without departing from the scope of the embodiments encompassed by the appended claims.

What is claimed is:

1. An annular antenna system, comprising:
a first ring assembly comprising:
(i) a first annular conductor;
(ii) a second annular conductor;
(iii) a first shorting wall that electrically couples the first annular conductor to the second annular conductor; and
(iv) at least two radio-frequency (RF) ports, each of the at least two RF ports configured to receive an RF signal and apply the RF signal across the first annular conductor and the second annular conductor.

2. The annular antenna system of claim 1, wherein
the first annular conductor comprises a first top surface, a first bottom surface, a first inner periphery and a first outer periphery,
the second annular conductor comprises a second top surface, a second bottom surface, a second inner periphery and a second outer periphery, and
the shorting wall electrically couples the first inner periphery to the second inner periphery.

3. The annular antenna system of claim 2, wherein the first top surface is substantially parallel to the second top surface.

4. The annular antenna system of claim 2, wherein the first annular conductor is separated from the second annular conductor by a dielectric material.

5. The annular antenna system of claim 2, wherein the first ring assembly is integrated with a projectile such that the first outer periphery and the second outer periphery are substantially flush with an outer surface of the projectile.

6. The annular antenna system of claim 2, wherein a distance from the first inner periphery to the first outer periphery is λ/4, where λ is a wavelength at an operating frequency of the annular antenna system.

7. The annular antenna system of claim 1, further comprising a second ring assembly comprising a third annular conductor, a fourth annular conductor, and a second shorting wall electrically coupling the third annular conductor to the fourth annular conductor.

8. The annular antenna system of claim 7, wherein the first ring assembly is characterized by a first set of physical dimensions, the second ring assembly is characterized by a second set of physical dimensions, and the first set of physical dimensions is substantially the same as the second set of physical dimensions.

9. The annular antenna system of claim 7, wherein a row of at least two electrically conductive posts is disposed such that each of the electrically conductive posts is electrically coupled to the first annular conductor and to the second annular conductor.

10. The annular antenna system of claim 1, wherein four RF ports are distributed on a top surface of the first annular conductor at about ninety-degree intervals, wherein each of the RF ports includes a housing electrically connected to the first annular conductor and a center conductor electrically connected to the second annular conductor.

11. The annular antenna system of claim 10, wherein an isolating wall is disposed between at least two adjacent RF ports, each isolating wall being electrically coupled to the first annular conductor and to the second annular conductor.

12. The annular antenna system of claim 11, wherein the isolating wall comprises a row of at least two conductive vias.

13. A method of determining a position of a first object in relation to a second object, the method comprising:
disposing an annular antenna system on the first object, wherein the annular antenna system comprises a first ring assembly that comprises (i) a first annular conductor, (ii) a second annular conductor, (iii) a first shorting wall that electrically couples the first annular conductor to the second annular conductor, and (iv) at least one radio-frequency (RF) port disposed on the first annular conductor, the at least one RF port is configured to receive an RF signal and apply the RF signal across the first annular conductor and the second annular conductor;
applying at least one RF signal pulse to the RF port; and
determining the position of the first object in relation to the second object based on a detected return signal.

14. The method of claim 13 wherein determining the position of the first object in relation to the second object includes determining the first object is within a predetermined proximity of the second object when the return signal detected at the at least one RF port is greater than a threshold value corresponding to the predetermined proximity.

15. The method of claim 13 wherein the at least one RF port comprises four RF ports disposed at ninety-degree intervals on the first annular conductor.

16. The method of claim 15 further comprising:
wherein applying the at least one RF signal pulse to the at least one RF port comprises:
applying a first RF signal pulse to each of the four RF ports, the four RF ports receiving signals with equal magnitudes and phases that advance by ninety degrees from RF port to RF port, and receiving a first return signal corresponding to the first RF signal pulse; and
applying a second RF signal pulse to each of the four RF ports, the four RF ports receiving equal magnitude signals and equal phase signals, and receiving a second return signal corresponding to the second RF signal pulse; and
wherein determining the position of the first object in relation to the second object comprises performing monopulse processing to determine that the first object is at a predetermined angle away from a longitudinal axis of a second object.

17. An annular antenna system, comprising:
a first ring assembly having a first shorting wall;
a second ring assembly having a second shorting wall, the second ring assembly being substantially parallel to the first ring assembly; and
four radio-frequency (RF) ports distributed on a top surface of the first ring assembly at ninety-degree intervals, wherein each of the RF ports has a housing electrically connected to the first ring assembly, each RF port configured to receive an RF signal and apply the RF signal to the first ring assembly.

18. The annular antenna system of claim 17, wherein
the first ring assembly comprises a first annular conductor and a second annular conductor, and the first shorting wall electrically couples the first annular conductor to the second annular conductor; and
the second ring assembly comprises a third annular conductor and a fourth annular conductor, and the second shorting wall electrically couples the third annular conductor to the fourth annular conductor.

19. The annular antenna system of claim 18, wherein the first annular conductor comprises a first top surface, a first bottom surface, a first inner periphery and a first outer periphery, and the second annular conductor comprises a second top surface, a second bottom surface, a second inner periphery and a second outer periphery.

20. The annular antenna system of claim 18, wherein the first annular conductor is separated from the second annular conductor by a dielectric material.
